(19) United States
(12) Patent Application Publication
(10) Pub. No.: US 2025/0007035 A1
(43) Pub. Date: Jan. 2, 2025

(54) HEAT EXCHANGER MANUFACTURING METHOD, HEAT EXCHANGER, POWER STORAGE DEVICE, AND POWER STORAGE DEVICE PACK

(71) Applicant: TOYOTA JIDOSHA KABUSHIKI KAISHA, Toyota-shi (JP)

(72) Inventor: Osamu YAMASHITA, Toyota-shi (JP)

(73) Assignee: TOYOTA JIDOSHA KABUSHIKI KAISHA, Toyota-shi (JP)

(21) Appl. No.: 18/756,726

(22) Filed: Jun. 27, 2024

(30) Foreign Application Priority Data
Jun. 29, 2023 (JP) 2023-107564

(51) Int. Cl. H01M 10/6555; B23K 1/00; B23K 101/14; F28F 3/02; F28F 21/08

(52) U.S. Cl. CPC H01M 10/6555; B23K 1/0012; F28F 3/025; F28F 21/084; B23K 2101/14; F28F 2275/04

(57) ABSTRACT

A heat exchanger manufactured by a heat exchanger manufacturing method of the present disclosure has a first metal plate and second metal plate, and a zigzag metal plate including a third metal plate formed in a zigzag shape. The zigzag metal plate has plural mountain portions joined to the first metal plate and plural valley portions joined to the second metal plate. The third metal plate deforms easily. The method includes: preparing a layered plate by layering the first metal plate, the third metal plate and the second metal plate in this order; joining the first metal plate and the third metal plate at regions of the layered plate that correspond to the mountain portions; and joining the second metal plate and the third metal plate at regions of the layered plate that correspond to the valley portions.

### CROSS-REFERENCE TO RELATED APPLICATION

This application is based on and claims priority under 35 USC 119 from Japanese Patent Application No. 2023-107564 filed on Jun. 29, 2023, the disclosure of which is incorporated by reference herein.

### BACKGROUND

### Technical Field

The present disclosure relates to a heat exchanger manufacturing method, a heat exchanger, a power storage device, and a power storage device pack.

### Related Art

Heat exchangers are conventionally used in order to cool or heat a target of heat exchange (e.g., a battery).

Japanese Patent Application Laid-Open (JP-A) No. 2013-111640 discloses a heat exchanger manufacturing method. The manufacturing method disclosed in JP-A No. 2013-111640 has a periphery welding step, a pressure reducing step, an interior welding step, and an expanding step. The periphery welding step, the pressure reducing step, the interior welding step and the expanding step are executed in this order. A heat exchanger 900 illustrated in FIG. 9 is obtained by the manufacturing method disclosed in JP-A No. 2013-111640. The heat exchanger 900 is a plate-shaped object.

In the periphery welding step, two plate members 910, 920 are superposed one on the other, and weld 930 is formed by a laser at the entire periphery of the outer peripheral end surface. In the pressure reducing step, air remaining in the gap between the two plate members 910, 920 is suctioned and discharged to the exterior by a vacuum pump from opening portions provided in advance in respective plate surfaces of the two plate members 910, 920. In the interior welding step, while the pressure-reduced state of the gap between the two plate members 910, 920 is maintained, welds 940 are formed by a laser at the two plate members 910, 920 at the plate surfaces thereof, such that the two plate members 910, 920 are divided into expansion portions 901 and a non-expansion portion 902. In the expanding step, a fluid is supplied under pressure into the expansion portions 901 such that the expansion portions 901 are deformed so as to expand.

At a heat exchanger 900, by causing the fluid to pass through the expansion portions 901, heat exchange is carried out between the fluid that passes through the expansion portions 901 and the fluid at the periphery that is the outer side of the heat exchanger 900.

As illustrated in FIG. 9, the both main surfaces of the heat exchanger 900 have convex-concave shapes. In a case in which a target of the heat exchange is made to directly contact a main surface of the heat exchanger 900, it is easy for the target of the heat exchange to contact only portions of the main surface of the heat exchanger 900 (specifically, only the plural expansion portions 901). Therefore, there is the concern that heat exchange of the target of the heat exchange will not be carried out efficiently. Further, in a case in which a target of the heat exchange is made to contact a main surface of the heat exchanger 900 indirectly via a heat conducting material (e.g., a heat conducting paste), in order for the heat exchange of the target of the heat exchange to be carried out efficiently, the concave portions of the convex-concave shape of the main surface of the heat exchanger 900 must be filled-in with the heat conducting material. Namely, there is the concern that a large amount of the heat conducting material will be used. Therefore, there is the need for a heat exchanger manufacturing method that can manufacture a heat exchanger whose both main surfaces are flat.

### SUMMARY

The present disclosure was made in view of the above-described circumstances. A topic that embodiments of the present disclosure address is the providing of a heat exchanger manufacturing method that can manufacture a heat exchanger whose both main surfaces are flat, and a heat exchanger, a power storage device, and a power storage device pack.

Means for addressing the aforementioned topic include the following embodying aspects.

<1> A heat exchanger manufacturing method of a first aspect of the present disclosure is a method of manufacturing a heat exchanger, wherein:
the heat exchanger has a first metal plate having at least one first through-hole, a second metal plate having at least one second through-hole, and a zigzag metal plate disposed between the first metal plate and the second metal plate, the zigzag metal plate comprising a third metal plate formed in a zigzag shape,
the zigzag metal plate has plural mountain portions joined to the first metal plate and plural valley portions joined to the second metal plate,
first flow paths that communicate with at least one the first through-hole are formed between the first metal plate and the zigzag metal plate, and second flow paths that communicate with at least one the second through-hole are formed between the second metal plate and the zigzag metal plate, and
the third metal plate deforms more easily than either of the first metal plate and the second metal plate,
the method including:
preparing a layered plate by layering the first metal plate, the third metal plate and the second metal plate in this order;
joining the first metal plate and the third metal plate at regions of the layered plate that correspond to the mountain portions; and
joining the second metal plate and the third metal plate at regions of the layered plate that correspond to the valley portions.

“Zigzag” means a shape that is bent like an undulating vine (i.e., is wave-shaped).

“Flow path” means a space through which a heat exchange medium flows.
“Deforms easily” means the quality of having relatively low rigidity and deforming easily due to the application of pressure.

In the first aspect, when fluid is supplied under pressure into the first through-hole and the second through-hole respectively of the layered plate, the regions of the third metal plate, which are among the regions that structure the respective first flow paths and second flow paths, are selectively pushed so as to widen, and the first flow paths and the second flow paths are formed. At this time, it is difficult for the first metal plate and the second metal plate respectively to deform. In other words, it is easy for the first metal plate and the second metal plate to maintain their shapes before the fluid was supplied under pressure into the respective first through-hole and second through-hole of the layered plate. As a result, the heat exchanger manufacturing method of the first aspect can manufacture a heat exchanger whose both main surfaces are flat.

Moreover, the zigzag metal plate that is hard to deform is usually manufactured by using a mold, and molds are expensive. As a result, the heat exchanger manufacturing method of the first aspect can manufacture a heat exchanger at a low cost.

<2> A heat exchanger manufacturing method of a second aspect of the present disclosure is the heat exchanger manufacturing method of above <1>, further including

supplying a fluid under pressure into at least one the first through-hole and at least one the second through-hole respectively, and pushing and widening the third metal plate.

In the second aspect, the first flow paths are formed between the first metal plate and the zigzag metal plate, and the second flow paths are formed between the second metal plate and the zigzag metal plate. As a result, the heat exchanger manufacturing method of the second aspect can manufacture a heat exchanger whose both main surfaces are flat.

<3> A heat exchanger manufacturing method of a third aspect of the present disclosure is the heat exchanger manufacturing method of above <1> or <2>, wherein:
the zigzag metal plate does not have third through-holes that communicate the first flow paths and the second flow paths,
the plural mountain portions include plural first mountain portions formed so as to be spaced apart at a first interval along a first direction that is orthogonal to a thickness direction of the heat exchanger, and
the plural valley portions include plural first valley portions formed so as to be spaced apart at a second interval along the first direction.

In the third aspect, the zigzag metal plate does not have third through-holes. Namely, the first flow paths and the second flow paths are independent. When fluid is supplied under pressure from the first through-hole of the layered plate, it is easier for the distribution of the magnitude of the pressure applied to the first metal plate to be uniform, than in a case in which the plural mountain portions do not have the plural first mountain portions that are formed so as to be spaced apart at the first interval. When a fluid is supplied under pressure from the second through-hole of the layered plate, it is easier for the distribution of the magnitude of the pressure applied to the second metal plate to be uniform, than in a case in which the plural valley portions do not have the plural first valley portions that are formed so as to be spaced apart at the second interval. As a result, the heat exchanger manufacturing method of the third aspect can manufacture a heat exchanger whose both main surfaces are even more flat.

<4> A heat exchanger manufacturing method of a fourth aspect of the present disclosure is the heat exchanger manufacturing method of above <3>, wherein:
the first mountain portions and the first valley portions respectively extend along a second direction that is orthogonal to each of the first direction and the thickness direction of the heat exchanger, and
the first mountain portions and the first valley portions are formed alternately along the first direction.

In the fourth aspect, when a fluid is supplied under pressure from the first through-hole of the layered plate, it is easier for the distribution of the magnitude of the pressure applied to the first metal plate to be uniform than in the third aspect. When a fluid is supplied under pressure from the second through-hole of the layered plate, it is easier for the distribution of the magnitude of the pressure applied to the second metal plate to be uniform than in the third aspect. As a result, the heat exchanger manufacturing method of the fourth aspect can manufacture a heat exchanger whose both main surfaces are even more flat.

<5> A heat exchanger manufacturing method of a fifth aspect of the present disclosure is the heat exchanger manufacturing method of any one of above <1> through <4>, wherein:
the first metal plate and the second metal plate respectively contain a 6000 series aluminum alloy, and
the third metal plate contains a 1000 series aluminum.

“6000 series aluminum alloy” means Al—Mg—Si aluminum alloys prescribed in JIS. “1000 series aluminum” means pure aluminums prescribed in JIS.

The rigidity of a 1000 series aluminum is lower than the rigidity of 6000 series aluminum alloys. Namely, it is easier for the third metal plate to deform than either of the first metal plate and the second metal plate. As a result, the heat exchanger manufacturing method of the fifth aspect can manufacture a heat exchanger whose both main surfaces are flat.

<6> A heat exchanger manufacturing method of a sixth aspect of the present disclosure is the heat exchanger manufacturing method of any one of above <1> through <5>, wherein:
respective thicknesses of the first metal plate and the second metal plate are greater than or equal to 1.00 mm, and
a thickness of the third metal plate is less than 1.00 mm.

The rigidity of the third metal plate is lower than the respective rigidities of the first metal plate and the second metal plate. Namely, it is easier for the third metal plate to deform than either of the first metal plate and the second metal plate. As a result, the heat exchanger manufacturing method of the sixth aspect can manufacture a heat exchanger whose both main surfaces are flat.

<7> A heat exchanger manufacturing method of a seventh aspect of the present disclosure is the heat exchanger manufacturing method of any one of above <1> through <6>, wherein:
the zigzag metal plate further has at least one third through-hole that communicates the first flow paths and the second flow paths,
the plural mountain portions include plural first mountain portions formed so as to be spaced apart at a first interval along a first direction that is orthogonal to a thickness direction of the heat exchanger,
the plural valley portions include plural first valley portions formed so as to be spaced apart at a second interval along the first direction, and
the first interval and the second interval are equal.

In the seventh aspect, the zigzag metal plate has third through-hole(s). Namely, the first flow paths and the second flow paths communicate with one another. The first interval and the second interval are equal. Due thereto, when fluid is supplied from the first through-hole and the second through-hole of the layered plate, it is easier for the distributions of the magnitudes of the pressures applied to either of the first metal plate and the second metal plate to be uniform than in a case in which the first interval and the second interval are not equal. As a result, the heat exchanger manufacturing method of the seventh aspect can manufacture a heat exchanger whose both main surfaces are even more flat.

<8> A heat exchanger manufacturing method of an eighth aspect of the present disclosure is the heat exchanger manufacturing method of any one of above <1> through <7>, further including:
readying a first brazing sheet in which a first brazing material layer for joining the plural mountain portions to the first metal plate is formed on one main surface of the first metal plate, and a second brazing sheet in which a second brazing material layer for joining the plural valley portions to the second metal plate is formed on one main surface of the second metal plate;
imparting the first brazing sheet with release agent by coating a first release agent on, of a main surface of the first brazing material layer, regions other than regions at which the plural mountain portions are to be joined; and
imparting the second brazing sheet with release agent by coating a second release agent on, of a main surface of the second brazing material layer, regions other than regions at which the plural valley portions are to be joined, wherein:
preparing the layered plate includes layering the first brazing sheet with release agent, the third metal plate and the second brazing sheet such that the first metal plate, the first brazing material layer, the third metal plate, the second brazing material layer and the second metal plate are layered in this order, and
joining the first metal plate and the third metal plate and joining the second metal plate and the third metal plate, includes heating the layered plate, brazing the first metal plate and the third metal plate, and brazing the second metal plate and the third metal plate.

In the eighth aspect, the first metal plate and the plural mountain portions are joined by brazing. The second metal plate and the plural valley portions are joined by brazing. As a result, the heat exchanger manufacturing method of the eighth aspect can manufacture a heat exchanger more simply than in a case in which the method of joining is not brazing.

<9> A heat exchanger of a ninth aspect of the present disclosure is
a heat exchanger, including a first metal plate having at least one first through-hole, a second metal plate having at least one second through-hole, and a zigzag metal plate disposed between the first metal plate and the second metal plate, the zigzag metal comprising a third metal plate formed in a zigzag shape, wherein:
the zigzag metal plate has plural mountain portions joined to the first metal plate and plural valley portions joined to the second metal plate,
first flow paths that communicate with at least one the first through-hole are formed between the first metal plate and the zigzag metal plate, and second flow paths that communicate with at least one the second through-hole are formed between the second metal plate and the zigzag metal plate, and
the zigzag metal plate deforms more easily than either of the first metal plate and the second metal plate.

In the ninth aspect, the zigzag metal plate deforms more easily than either of the first metal plate and the second metal plate. Namely, the third metal plate deforms more easily than either of the first metal plate and the second metal plate. The heat exchanger of the ninth aspect is suitably manufactured by the heat exchanger manufacturing method of the first aspect. Therefore, the both main surfaces of the heat exchanger of the ninth aspect are flat. As a result, the heat exchanger of the ninth aspect can efficiently adjust the heat of targets of heat exchange.

<10> A heat exchanger of a tenth aspect of the present disclosure is the heat exchanger of above <9>, wherein

a main surface of the first metal plate and a main surface of the second metal plate are each planar.

In the tenth aspect, it is easier for the main surface of the first metal plate and the main surface of the second metal plate to directly contact targets of heat exchange than in a case in which the main surface of the first metal plate and the main surface of the second metal plate are not each planar. As a result, the heat exchanger of the tenth aspect can more efficiently adjust the heat of targets of heat exchange.

<11> A heat exchanger of an eleventh aspect of the present disclosure is the heat exchanger of above <9>, wherein

a thickness of the heat exchanger is less than or equal to 10 mm.

The heat exchanger of the eleventh aspect is suitably used as a cooler for cooling the power storing modules included in the power storage device of a twelfth aspect that is described hereinafter.

<12> A power storage device of a twelfth aspect of the present disclosure is a power storage, device including:
plural power storing modules that are stacked; and
the plural heat exchangers according to any one of above <9> through <11>, which are provided between the power storing modules that are adjacent to one another in a stacking direction of the power storing modules, wherein:
each of the power storing modules has an electrode stack including plural electrodes layered via separators along the stacking direction of the power storing modules, an electrolytic liquid accommodated in internal spaces formed between the electrodes that are adjacent to one another, and a sealing body that surrounds side surfaces, which run along the stacking direction, of the electrode stack and that seals the internal spaces,
the plural electrodes include a negative electrode final end electrode, a positive electrode final end electrode, and plural bipolar electrodes layered between the negative electrode final end electrode and the positive electrode final end electrode,
each of the plural bipolar electrodes includes an electrode plate, a positive electrode provided on a first surface of the electrode plate, and a negative electrode provided on a second surface of the electrode plate,
the electrode stack has, at one end and another end in the stacking direction, electrode exposed regions that are exposed from the sealing body, and
between the power storing modules that are adjacent to one another in the stacking direction, the heat exchangers are disposed between the electrode exposed regions that face one another, so as to contact the electrode exposed regions.

In the twelfth aspect, the both main surfaces of the heat exchanger are flat. Therefore, the surface area of contact between the electrode exposed regions and the heat exchangers is greater than in a case in which the both main surfaces of the heat exchanger are not flat. As a result, the power storage device of the twelfth aspect can efficiently adjust the heat of the power storing modules.

A power storage device pack of the present disclosure is a power storage device pack, including:
the power storage device of above <12>; and
a lower case accommodating the power storage device.

The power storage device pack of the thirteenth aspect can efficiently adjust the heat of the power storing modules.

In accordance with the present disclosure, there are provided a heat exchanger manufacturing method that can manufacture a heat exchanger whose both main surfaces are flat, and a heat exchanger, a power storage device, and a power storage device pack.

### BRIEF DESCRIPTION OF THE DRAWINGS

Exemplary embodiments of the present invention will be described in detail based on the following figures, wherein:

FIG. 1 is a cross-sectional view of a heat exchanger relating to a first embodiment of the present disclosure;

FIG. 2 is a cross-sectional view along line C2-C2 of the heat exchanger of FIG. 1;

FIG. 3 is a cross-sectional view along line C3-C3 of the heat exchanger of FIG. 1;

FIG. 4 is a drawing for explaining a heat exchanger manufacturing method of the first embodiment of the present disclosure;

FIG. 5 is a drawing for explaining the heat exchanger manufacturing method of the first embodiment of the present disclosure;

FIG. 6 is a cross-sectional view of a power storage device pack relating to the first embodiment of the present disclosure;

FIG. 7 is a cross-sectional view of a power storing module in the first embodiment of the present disclosure;

FIG. 8 is a cross-sectional view of a heat exchanger relating to a second embodiment of the present disclosure; and

FIG. 9 is a cross-sectional view of a conventional heat exchanger.

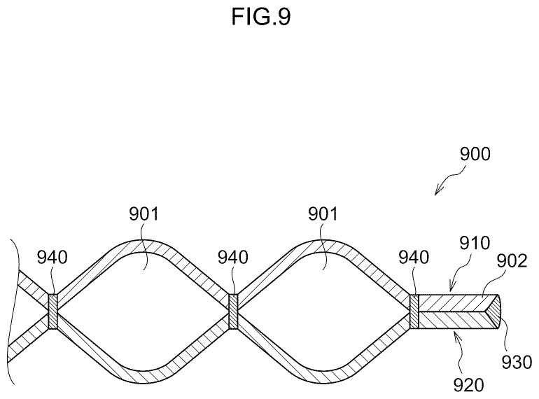

### DETAILED DESCRIPTION

In the present disclosure, numerical ranges expressed by using “˜” mean ranges in which the numerical values listed before and after the “˜” are included as the minimum value and maximum value, respectively. In numerical value ranges that are expressed in a stepwise manner in the present disclosure, the upper limit value or the lower limit value listed in a given numerical value range may be substituted by the upper limit value or the lower limit value of another numerical value range that is expressed in a stepwise manner. In the present disclosure, combinations of two or more preferable aspects are more preferable aspects. In the present disclosure, the term “step” is not only an independent step, and includes steps that, in a case in which that step cannot be clearly distinguished from another step, achieve the intended object of that step.

Embodiments of a heat exchanger manufacturing method, a heat exchanger, a power storage device, and a power storage device pack of the present disclosure are described hereinafter with reference to the drawings. In the drawings, portions that are the same or equivalent are denoted by the same reference numerals, and description thereof is not repeated.

### (1) First Embodiment

A heat exchanger manufacturing method of a first embodiment of the present disclosure is a method of manufacturing heat exchanger 1A.

### (1.1) Heat Exchanger

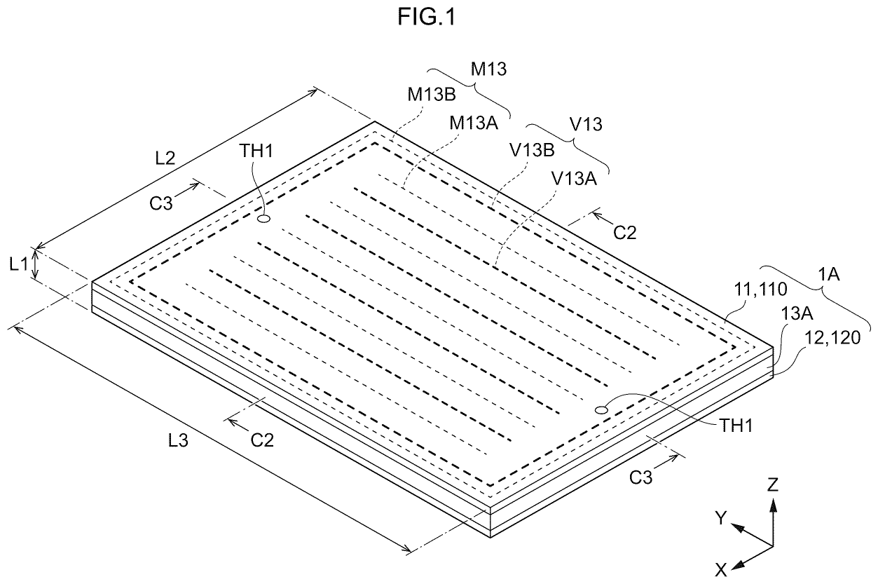

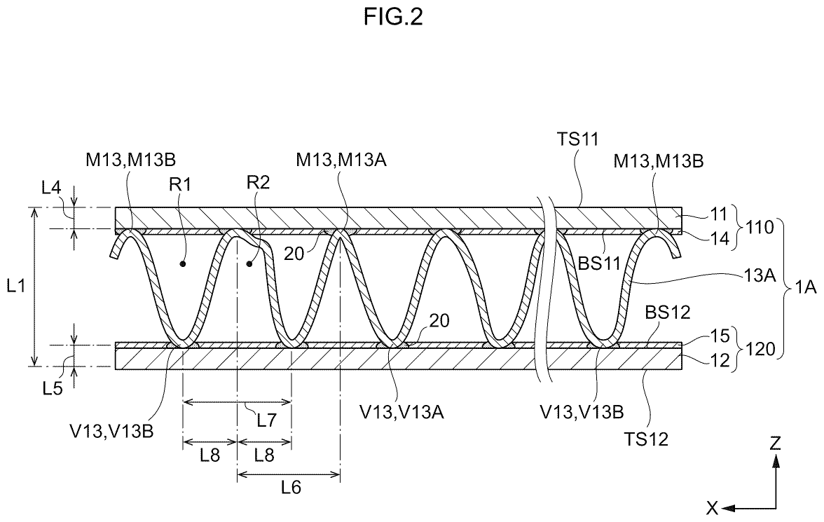

As illustrated in FIG. 1 and FIG. 2, the heat exchanger 1A has a first metal plate 11, a second metal plate 12, a zigzag metal plate 13A, a first brazing material layer 14 (see FIG. 2), and a second brazing material layer 15 (see FIG. 2). The first brazing material layer 14 is layered on main surface BS11 of the first metal plate 11. The second brazing material layer 15 is layered on main surface BS12 of the second metal plate 12. The zigzag metal plate 13A is disposed between the first metal plate 11 and the second metal plate 12. The zigzag metal plate 13A is brazed to the first metal plate 11 and the second metal plate 12 by the first brazing material layer 14 and the second brazing material layer 15. The heat exchanger 1A is an object that is shaped as a hexahedron.

Hereinafter, one side in the thickness direction of the heat exchanger 1A is defined as the Z-axis positive direction, and the side opposite thereto is defined as the Z-axis negative direction. One side in the direction in which one side of the main surface of the heat exchanger 1A extends is defined as the X-axis positive direction, and the side opposite thereto is defined as the X-axis negative direction. (The X-axis direction is an example of the first direction.) One side in the direction orthogonal to the X-axis of the main surface of the heat exchanger 1A is defined as the Y-axis positive direction, and the side opposite thereto is defined as the Y-axis negative direction. (The Y-axis direction is an example of the second direction.) The X-axis, the Y-axis and the Z-axis are orthogonal to one another. Note that these directions do not limit the directions at the time of usage of the heat exchanger 1A.

Thickness L1 (length L1 in the Z-axis direction) (see FIG. 2) of the heat exchanger 1A is less than or equal to 10 mm. The thickness L1 may be 4 mm˜5 mm. Length L2 in the X-axis direction of the heat exchanger 1A and length L3 in the Y-axis direction of the heat exchanger 1A may be 1000 mm˜ 2000 mm for example. The length L2 and the length L3 may be the same or may be different.

The heat exchanger 1A is preferably used as a cooler that cools a power storing module of a power storage device pack that is described later.

### (1.1.1) First Metal Plate

The first metal plate 11 is a flat-plate-shaped object. Main surface TS11 (an example of the main surface) of the first metal plate 11 is planar. The first metal plate 11 has two first through-holes TH1. Thickness L4 (see FIG. 2) of the first metal plate 11 is greater than or equal to 1.00 mm. The thickness LA may be 1.00 mm˜ 3.00 mm, and may be 1.6 mm. The first metal plate 11 contains a 6000 series aluminum alloy, and may be a 6000 series aluminum alloy. Examples of 6000 series aluminum alloys are aluminum alloys of alloy numbers 6101, 6061, 6082 and the like.

### (1.1.2) Second Metal Plate

The second metal plate 12 is a flat-plate-shaped object. Main surface TS12 (an example of the main surface) of the second metal plate 12 is planar. The second metal plate 12 has two second through-holes TH2. Thickness L5 (see FIG. 2) of the second metal plate 12 is greater than or equal to 1.00 mm. The thickness L5 may be 1.00 mm˜ 3.00 mm, and may be 1.6 mm. The second metal plate 12 contains a 6000 series aluminum alloy, and may be a 6000 series aluminum alloy. The second metal plate 12 may be the same as, or may be different than, the first metal plate 11.

### (1.1.3) Zigzag Metal Plate

The zigzag metal plate 13A is formed by a third metal plate (not illustrated) being formed into a zigzag shape. The third metal plate is a flat-plate-shaped object. The third metal plate and the zigzag metal plate 13A deform more easily than either of the first metal plate 11 and the second metal plate 12. Specifically, the third metal plate is less than 1.00 mm, and may be 0.6 mm˜ 0.1 mm, and may be 0.3 mm. The third metal plate contains a 1000 series aluminum, and may be a 1000 series aluminum. Examples of 1000 series aluminums are pure aluminums of alloy numbers 1085, 1080, 1070, 1060, 1050, 1050A and the like.

As illustrated in FIG. 2, the zigzag metal plate 13A has plural mountain portions M13 joined to the first metal plate 11 by the first brazing material layer 14, and plural valley portions V13 joined to the second metal plate 12 by the second brazing material layer 15.

The plural mountain portions M13 include plural rectilinear mountain portions M13A (an example of the first mountain portions), and a frame-shaped mountain portion M13B formed along the peripheral edge of the first metal plate 11. The rectilinear mountain portions M13A extend along the Y-axis direction. The plural rectilinear mountain portions M13A are respectively formed so as to be spaced apart at a first interval L6 along the X-axis direction. The frame-shaped mountain portion M13B surrounds the plural rectilinear mountain portions M13A.

The plural valley portions V13 include plural rectilinear valley portions V13A (an example of the first valley portions), and a frame-shaped valley portion V13B formed along the peripheral edge of the first metal plate 11. The rectilinear valley portions V13A extend along the Y-axis direction. The plural rectilinear valley portions V13A are respectively formed so as to be spaced apart at a second interval L7 along the X-axis direction. The frame-shaped valley portion V13B surrounds the plural rectilinear valley portions V13A. In the first embodiment, the second interval L7 is the same as the first interval L6.

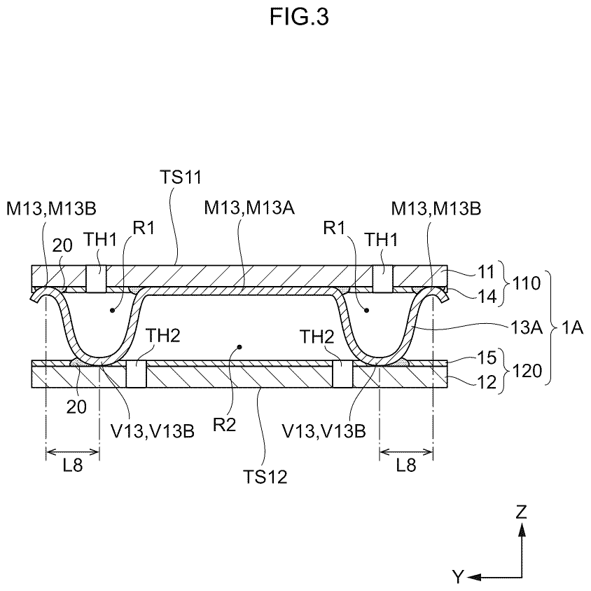

The frame-shaped mountain portion M13B surrounds the frame-shaped valley portion V13B. Interval L8 (see FIG. 3) is formed between the frame-shaped mountain portion M13B and the frame-shaped valley portion V13B in both the X-axis direction and the Y-axis direction. In the X-axis direction, the interval L8 (see FIG. 2) is formed between the rectilinear mountain portion M13A and the rectilinear mountain portion M13A that is adjacent thereto. The length of the interval L8 is a length that is one-half of the length of the first interval L6 and is one-half of the length of the second interval L7, respectively.

First flow paths R1 that communicate with the first through-holes TH1 are formed between the first metal plate 11 and the zigzag metal plate 13A. Second flow paths R2 that communicate with the second through-holes TH2 are formed between the second metal plate 12 and the zigzag metal plate 13A. In the first embodiment, third through-holes that communicate the first flow paths R1 and the second flow paths R2 are not formed in the zigzag metal plate 13A. The first flow paths R1 and the second flow paths R2 are independent.

### (1.1.4) First Brazing Material Layer

The material of the first brazing material layer 14 is not particularly limited, provided that it can braze the plural mountain portions M13 of the zigzag metal plate 13A to the first metal plate 11, and may be a known brazing material. The thickness of the first brazing material layer 14 may be, for example, 10% of the total thickness of the first metal plate 11 and the first brazing material layer 14.

### (1.1.5) Second Brazing Material Layer

The material of the second brazing material layer 15 is not particularly limited, provided that it can braze the plural valley portions V13 of the zigzag metal plate 13A to the second metal plate 12, and may be a known brazing material. The thickness of the second brazing material layer 15 may be, for example, 10% of the total thickness of the second metal plate 12 and the second brazing material layer 15.

### (1.1.6) Operation

At the heat exchanger 1A, when a cooling medium is supplied to one of the two first through-holes TH1, the cooling medium flows through the first flow paths R1 and is discharged from the another of the two first through-holes TH1. When a cooling medium is supplied to one of the two second through-holes TH2, the cooling medium flows through the second flow paths R2 and is discharged from the another of the two second through-holes TH2. Due to the cooling medium circulating through the interior of the heat exchanger 1A in this way, the heat exchanger 1A can cool targets of heat exchange that are made to thermally contact the main surface TS11 of the first metal plate 11 and the main surface TS12 of the second metal plate 12, respectively.

### (1.2) Heat Exchanger Manufacturing Method

The heat exchanger manufacturing method of the first embodiment includes a readying step, a first release agent coating step, a second release agent coating step, a layering step, a joining step, and a step of supplying under pressure. The order of executing the first release agent coating step and the second release agent coating step is not particularly limited provided that these steps are executed after execution of the readying step and before execution of the layering step. The layering step, the joining step and the step of supplying under pressure are executed in this order after execution of the first release agent coating step and the second release agent coating step.

Hereinafter, the first metal plate 11 and the first brazing material layer 14 are collectively called a “first brazing sheet 110”. Hereinafter, the second metal plate 12 and the second brazing material layer 15 are collectively called a “second brazing sheet 120”.

### (1.2.1) Readying Step

In the readying step, the first brazing sheet 110 and the second brazing sheet 120 are readied. The method of readying the first brazing sheet 110 and the second brazing sheet 120 is not particularly limited, and it suffices for this method to be a known method.

### (1.2.2) First Release Agent Coating Step

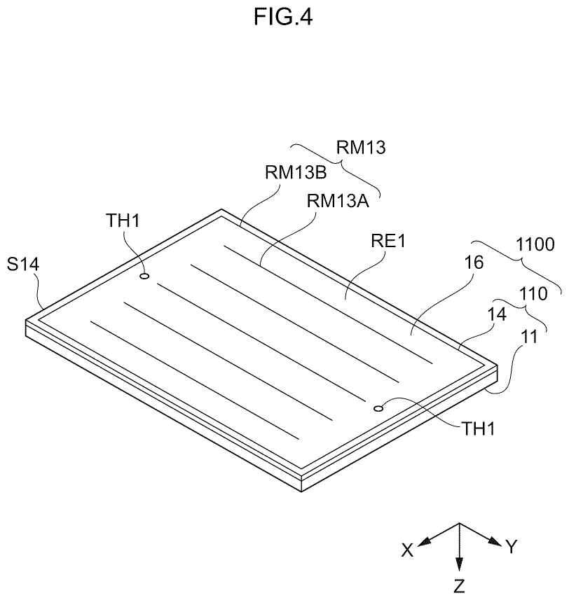

In the first release agent coating step, as illustrated in FIG. 4, a first release agent is coated on region RE1, which is other than regions RM13 where the plural mountain portions M13 are joined, of main surface S14 of the first brazing material layer 14 of the first brazing sheet 110. A first brazing sheet 1100 with release agent is thereby impartinged.

The first brazing sheet 1100 with release agent has the first brazing sheet 110 and a coated layer 16 of the first release agent. The regions RM13 include regions RM13A where the plural rectilinear mountain portions M13A are joined, and region RM13B where the frame-shaped mountain portion M13B is joined.

The method of coating the first release agent is not particularly limited, and a first coating method and the like are examples thereof. In the first coating method, masking tape is affixed to only the regions RM13A, where the plural mountain portions M13 are to be joined, of the first brazing material layer 14, and the first release agent is coated on the region (i.e., the region RE1) of the first brazing material layer 14 where the masking tape is not affixed, and the masking tape is peeled off from the first brazing material layer 14. The material of the first release agent is not particularly limited provided that it is a material that prevents brazing of the first brazing material layer 14 and the third metal plate, and may be a known release agent (e.g., boron nitride).

### (1.2.3) Second Release Agent Coating Step

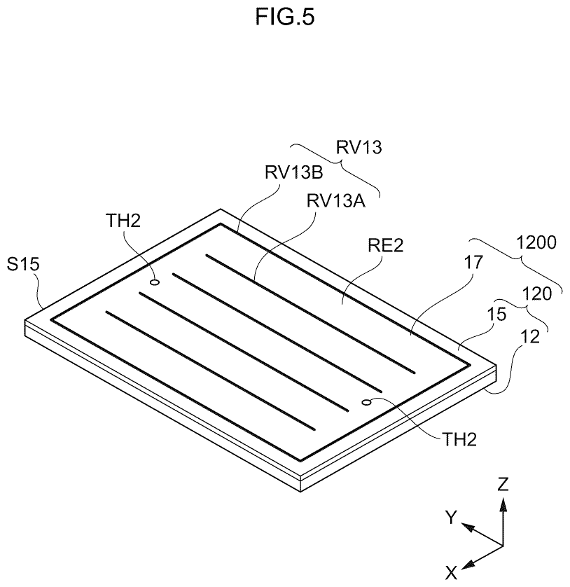

In the second release agent coating step, as illustrated in FIG. 5, a second release agent is coated on region RE2, which is other than regions RV13 where the plural valley portions V13 are joined, of main surface S15 of the second brazing material layer 15. A second brazing sheet 1200 with release agent is thereby imparted.

The second brazing sheet 1200 with release agent has the second brazing sheet 120 and a coated layer 17 of the second release agent. The regions RV13 include regions RV13A where the plural rectilinear valley portions V13A are joined, and region RV13B where the frame-shaped valley portion V13B is joined.

The method of coating the second release agent is not particularly limited, and a second coating method and the like are examples thereof. In the second coating method, masking tape is affixed to only the regions RV13A, where the plural valley portions V13 are to be joined, of the second brazing material layer 15, and the second release agent is coated on the region (i.e., the region RE2) of the second brazing material layer 15 where the masking tape is not affixed, and the masking tape is peeled off from the second brazing material layer 15. The material of the second release agent is not particularly limited provided that it is a material that prevents brazing of the second brazing material layer 15 and the third metal plate, and may be a known release agent. The second release agent may be the same as or may be different than the first release agent.

### (1.2.4) Layering Step

In the layering step, the first brazing sheet 1100 with release agent, the third metal plate and the second brazing sheet 1200 with release agent are layered such that the first metal plate 11, the first brazing material layer 14, the third metal plate, the second brazing material layer 15 and the second metal plate 12 are layered in this order, and a layered plate is prepared. The method of layering is not particularly limited, and it suffices for the method to be a known method. The size of the third metal plate may be the same as or may be different than that of the first metal plate 11 and the second metal plate 12.

### (1.2.5) Joining Step

In the joining step, the layered plate is heated, the first metal plate 11 and the third metal plate are joined, and the second metal plate 12 and the third metal plate are joined. In detail, in the first embodiment, at the region RM13B where the coated layer 16 of the first release agent is not formed, the first metal plate 11 and the third metal plate are brazed. At the region RE1 where the coated layer 16 of the first release agent is formed, the first metal plate 11 and the third metal plate are not brazed. At the region RV13B where the coated layer 17 of the second release agent is not formed, the second metal plate 12 and the third metal plate are brazed. At the region RE2 where the coated layer 17 of the second release agent is formed, the second metal plate 12 and the third metal plate are not brazed. The method of heating the layered plate is not particularly limited, and it suffices for the method to be a known method.

### (1.2.6) Step of Supplying Under Pressure

In the step of supplying under pressure, a fluid is supplied under pressure into the first through-hole TH1 and second through-hole TH2 respectively of the layered plate, and the third metal plate is pushed so as to widen. The reason why the third metal plate is pushed and widened by the fluid is because the third metal plate and the zigzag metal plate 13A deform more easily than the first metal plate 11 and the second metal plate 12. It is easy for the first metal plate 11 and the second metal plate 12, after the step of supplying under pressure has been carried out, to maintain their shapes of the states before execution of the step of supplying under pressure. Due to the execution of step of supplying under pressure, the first flow paths R1 and the second flow paths R2 are formed. The liquid is not particularly limited provided that it can push the third metal plate to widen, and examples thereof are gasses, liquids, and the like. The fluid may be a cooling medium. Examples of the cooling medium are liquids for cooling, gasses for cooling, and the like. The liquids for cooling are not particularly limited provided that they are liquids that are generally used for cooling, and examples thereof are water, oil, glycol-based aqueous solutions, coolants for air conditioning, non-electrically conductive liquids, phase change liquids, and the like.

Examples of gasses for cooling are air, nitrogen gas and the like. The temperature of the cooling medium is adjusted appropriately in accordance with the type of the target of the heat exchange, and the like. From the standpoint of cleaning the first flow paths R1 and the second flow paths R2 after execution of the step of supplying under pressure, the fluid is preferably a gas. The method of supplying the fluid under pressure is appropriately selected in accordance with the type of the fluid and the like, and it suffices for the method to be a known method.

### (1.3) Power Storage Device Pack

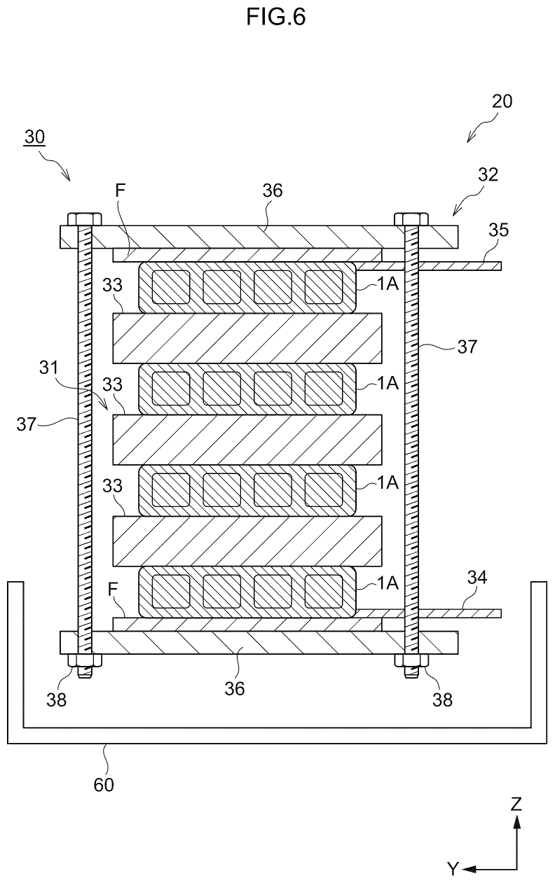

As illustrated in FIG. 6, a power storage device pack 20 of the first embodiment of the present disclosure has a power storage device 30 and a lower case 60. The lower case 60 houses the power storage device 30.

### (1.3.1) Power Storage Device

The power storage device pack 20 has the power storage device 30.

The power storage device 30 is used as the battery of any of various types of vehicles such as, for example, a forklift, a hybrid vehicle, an electric vehicle or the like. As illustrated in FIG. 6, the power storage device 30 has a module stack 31 and a restraining member 32. The restraining member 32 applies a restraining load to the module stack 31 in the stacking direction of the module stack 31.

The module stack 31 has plural power storing modules 33 and the plural heat exchangers 1A that are stacked. As an example, the power storing module 33 is a bipolar battery. The power storing module 33 is, for example, a secondary battery such as a nickel-hydrogen secondary battery, a lithium ion secondary battery or the like. The module stack 31 is rectangular when viewed from the stacking direction (i.e., the Z direction).

The power storing modules 33 that are adjacent to one another in the stacking direction are electrically connected via the heat exchangers 1A. The heat exchangers 1A are disposed between the power storing modules 33 that are adjacent to one another in the stacking direction, and at the outer sides of the power storing modules 33 that are positioned at the ends of the stack, respectively. A positive electrode terminal 34 is connected to one of the heat exchangers 1A that is disposed at the outer side of the power storing module 33 positioned at an end of the stack. A negative electrode terminal 35 is connected to the other of the heat exchangers 1A that is disposed at the outer side of the power storing module 33 positioned at an end of the stack. The positive electrode terminal 34 and the negative electrode terminal 35 are drawn out from edge portions of the heat exchangers 1A for example, in a direction intersecting the stacking direction. Charging/discharging of the power storage device 30 are carried out by the positive electrode terminal 34 and the negative electrode terminal 35.

The heat exchangers 1A have the function of connecting members that electrically connect the power storing modules 33 to one another, and the function of heat dissipating plates that dissipate the heat generated at the power storing modules 33.

The restraining member 32 is structured by a pair of end plates 36 that sandwich the module stack 31 in the stacking direction, and fastening bolts 37 and nuts 38 that fasten the end plates 36 together. Films F that are electrically insulating are provided at the surfaces, which are at the module stack 31 sides, of the end plates 36. The films F electrically insulate the end plates 36 and the heat exchangers 1A.

### (1.3.1.1) Power Storing Module

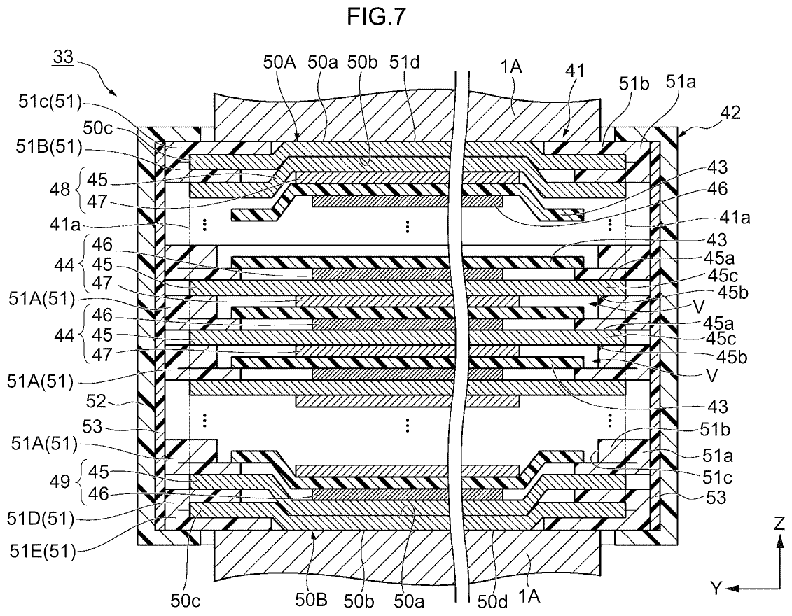

As illustrated in FIG. 7, the power storing module 33 has an electrode stack 41, and a sealing body 42 that is made of resin and that seals the electrode stack 41. The power storing module 33 is formed in a rectangular parallelopiped shape for example.

The electrode stack 41 includes plural electrodes that are stacked along the stacking direction via separators 43, and collectors (metal plates 50A, 50B) positioned at the stack ends of the electrode stack 41. The plural electrodes include negative electrode final end electrode 48, positive electrode final end electrode 49, and plural bipolar electrodes 44 stacked between the negative electrode final end electrode 48 and the positive electrode final end electrode 49. The stack of the plural bipolar electrodes 44 is provided between the negative electrode final end electrode 48 and the positive electrode final end electrode 49.

The bipolar electrode 44 has a metal plate 45 serving as a collector, a positive electrode 46, and a negative electrode 47. The metal plate 45 has a first surface 45a, and a second surface 45b provided at the side opposite the first surface 45a. The positive electrode 46 is provided on the first surface 45a, and the negative electrode 47 is provided on the second surface 45b. The positive electrode 46 is a positive electrode active material layer formed by a positive electrode active material being coated on the metal plate 45. The negative electrode 47 is a negative electrode active material layer formed by a negative electrode active material being coated on the metal plate 45. At the electrode stack 41, the positive electrode 46 of one bipolar electrode 44 faces the negative electrode 47 of another bipolar electrode 44 that is adjacent thereto at one side in the stacking direction, with the separator 43 located therebetween. At the electrode stack 41, the negative electrode 47 of one bipolar electrode 44 faces the positive electrode 46 of another bipolar electrode 44 that is adjacent thereto at another side in the stacking direction, with the separator 43 located therebetween.

The negative electrode final end electrode 48 has the metal plate 45, and the negative electrode 47 that is provided at the second surface 45b of the metal plate 45. The negative electrode final end electrode 48 is disposed at one end side in the stacking direction such that the second surface 45b faces the central side in the stacking direction at the electrode stack 41. The metal plate 50A is further stacked on the first surface 45a of the metal plate 45 of the negative electrode final end electrode 48, and the negative electrode final end electrode 48 is electrically connected to the one heat exchanger 1A, which is adjacent to the power storing module 33, via this metal plate 50A. The negative electrode 47, which is provided at the second surface 45b of the metal plate 45 of the negative electrode final end electrode 48, faces, via the separator 43, the positive electrode 46 of the bipolar electrode 44 that is at one end in the stacking direction.

The positive electrode final end electrode 49 has the metal plate 45, and the positive electrode 46 that is provided at the first surface 45a of the metal plate 45. The positive electrode final end electrode 49 is disposed at the another end side in the stacking direction such that the first surface 45a faces the central side in the stacking direction at the electrode stack 41. The metal plate 50B is further stacked on the second surface 45b of the metal plate 45 of the positive electrode final end electrode 49, and the positive electrode final end electrode 49 is electrically connected to the another heat exchanger 1A, which is adjacent to the power storing module 33, via this metal plate 50B. The positive electrode 46, which is provided at the first surface 45a of the metal plate 45 of the positive electrode final end electrode 49, faces, via the separator 43, the negative electrode 47 of the bipolar electrode 44 that is at the another end in the stacking direction.

The material of the metal plate 45 is a metal (e.g., Al, SUS, Ni, Cu or the like). Each of the metal plates 45 is one metal plate that is included in the electrode stack 41. Examples of the positive electrode active material that structures the positive electrode 46 are oxide active materials. Examples of oxide active materials are layered rock salt type active materials such as LiCoO₂, LiMnO₂, LiNiO₂, LiVO₂, LiNi_{1/3}Co_{1/3}Mn_{1/3}O₂ and the like, spinel type active materials such as LiMn₂O₄, Li(Ni_{0.5}Mn_{1.5})O₄ and the like, and olivine type active materials such as LiFePO₄, LiMnPO₄, LiNiPO₄, LiCuPO₄ and the like. Examples of the negative electrode active material that structures the negative electrode 47 are carbon active materials, oxide active materials, and metal active materials. The electrode stack 41 has the plural metal plates 45, 50A, 50B that are stacked.

The separator 43 is a member for preventing short-circuiting between the metal plates 45, and is a sheet-shaped object for example. Examples of the separator 43 are porous films formed from polyolefin resins such as polyethylene (PE), polypropylene (PP) and the like, woven or non-woven fabrics formed from polypropylene, methyl cellulose or the like, and the like. The separators 43 may be reinforced by vinylidene fluoride resin compounds. Note that the separators 43 are not limited to being sheet-shaped, and may be bag-shaped.

The metal plates 50A, 50B are members that are substantially the same as the metal plates 45. The material of the metal plates 50A, 50B is a metal (e.g., Al, SUS, Ni, Cu or the like). The metal plates 50A, 50B are each one metal plate included in the electrode stack 41. The metal plates 50A, 50B form uncoated electrodes at which neither of a positive electrode active material layer nor a negative electrode active material layer is formed on a first surface 50a and a second surface 50b. Namely, the metal plates 50A, 50B are uncoated electrodes at which an active material layer is not provided on either surface thereof.

Due to the metal plate 50A, the negative electrode final end electrode 48 is in a state of being disposed between the metal plate 50A and the bipolar electrode 44 along the stacking direction. The second surface 50b of the metal plate 50A and the first surface 45a of the metal plate 45 of the negative electrode final end electrode 48 are electrically connected by direct contact without anything interposed therebetween. Due to the metal plate 50B, the positive electrode final end electrode 49 is in a state of being disposed between the metal plate 50B and the bipolar electrode 44 along the stacking direction. The first surface 50a of the metal plate 50B and the second surface 45b of the metal plate 45 of the positive electrode final end electrode 49 are electrically connected by direct contact without anything interposed therebetween.

At the electrode stack 41, the central region of the electrode stack 41 (the region where the active material layers are disposed at the bipolar electrodes 44, the negative electrode final end electrode 48 and the positive electrode final end electrode 49) bulges-out in the stacking direction as compared with the region at the periphery thereof. Therefore, the metal plates 50A, 50B are bent in directions in which the central regions of the metal plates 50A, 50B move away from one another.

The electrode stack 41 has electrode exposed portions 50d that are exposed from the sealing body 42 at the one end and the another end in the stacking direction (the Z-axis direction). The electrode exposed portions 50d are structured by the central regions of the negative electrode final end electrode 48 and the positive electrode final end electrode 49, which central regions are exposed from the sealing body 42. Between the power storing modules 33 that are adjacent to one another in the stacking direction, the heat exchangers 1A are disposed between the electrode exposed portions 50d, which face one another, so as to contact the electrode exposed portions 50d.

The sealing body 42 is, overall, formed in the shape of a rectangular tube by an insulative resin for example. The sealing body 42 is provided so as to surround side surfaces 41a of the electrode stack 41. The sealing body 42 seals internal spaces V that are provided within the electrode stack 41.

The sealing body 42 has plural first sealing portions 51 (resin portions) that are frame-shaped, and a second sealing portion 52. The first sealing portions 51 are respectively provided at the edge portions of the metal plates included in the electrode stack 41 (i.e., edge portions 45c of the metal plates 45 and edge portions 50c of the metal plates 50A, 50B). The second sealing portion 52 surrounds the plural, frame-shaped first sealing portions 51 (resin portions), and the first sealing portions 51 along the side surfaces 41a from the outer sides, and is joined to the respective first sealing portions 51. The first sealing portions 51 and the second sealing portion 52 are insulative resins for example, and examples of structural materials of the resins are polypropylene (PP), polyphenylene sulfide (PPS), modified polyphenylene ether (modified PPE) and the like.

The first sealing portions 51 are provided continuously over the entire peripheries of the edge portions 45c of the metal plates 45 and the edge portions 50c of the metal plates 50A, 50B, and are formed in the shapes of rectangular frames as seen from the stacking direction. The first sealing portions 51 and the metal plates 45, and the first sealing portions 51 and the metal plates 50A, 50B, respectively, are joined airtightly. As seen from the stacking direction, the first sealing portions 51 extend to further toward the outer sides than the edge portions 45c of the metal plates 45 and the edge portions 50c of the metal plates 50A, 50B. The first sealing portions 51 include outer side portions 51a that jut-out further toward the outer sides than the edges of the metal plates 45 and the metal plates 50A, 50B, and inner side portions 51b positioned further toward the inner sides than the edges of the metal plates 45 and the metal plates 50A, 50B. Deposited layers 53 are formed at the distal end portions (the outer edge portions) of the outer side portions 51a of the first sealing portions 51.

The plural first sealing portions 51 include plural first sealing portions 51A provided at the bipolar electrodes 44 and the positive electrode final end electrode 49, a first sealing portion 51B provided at the negative electrode final end electrode 48, a first sealing portion 51C provided at the metal plate 50A, and first sealing portions 51D, 51E provided at the metal plate 50B.

The first sealing portions 51A are joined to the first surfaces 45a of the metal plates 45 of the bipolar electrodes 44 and the positive electrode final end electrode 49. The inner side portions 51b of the first sealing portions 51A are positioned between the edge portions 45c of the metal plates 45 that are adjacent to one another in the stacking direction. The overlapping regions of the edge portions 45c at the first surfaces 45a of the metal plates 45 and the first sealing portions 51A are the joined regions of the metal plates 45 and the first sealing portions 51A.

In the present embodiment, the first sealing portion 51A is formed as a two-layer structure due to a single film being folded-over in two. The outer edge portions of the first sealing portions 51A that are embedded in the second sealing portion 52 are the folded-over portions (the bent portions) of the films. The film of the first layer that structures the first sealing portion 51A is joined to the first surface 45a. The inner edge of the film of the second layer is positioned further toward the outer side than the inner edge of the film of the first layer, and forms a step portion on which the separator 43 is placed. The inner edge of the film of the second layer is positioned further toward the inner side than the edge of the metal plate 45.

The first sealing portion 51B is joined to the first surface 45a of the metal plate 45 of the negative electrode final end electrode 48. The inner side portion 51b of the first sealing portion 51B is positioned between the edge portion 45c of the metal plate 45 of the negative electrode final end electrode 48, and the edge portion 50c of the metal plate 50A, which are adjacent to one another in the stacking direction. The overlapping region of the edge portion 45c at the first surface 45a of the metal plate 45 and the inner side portion 51b of the first sealing portion 51B is the joined region of the metal plate 45 and the first sealing portion 51B. The first sealing portion 51B is joined also to the second surface 50b of the metal plate 50A. The overlapping region of the edge portion 50c at the second surface 50b of the metal plate 50A and the first sealing portion 51B is the joined region of the metal plate 50A and the first sealing portion 51B. The first sealing portion 51B is joined also to the edge portion 50c at the second surface 50b of the metal plate 50A.

The first sealing portion 51C is joined to the first surface 50a (the outer surface) of the metal plate 50A. The overlapping region of the edge portion 50c at the first surface 50a of the metal plate 50A and the first sealing portion 51C is the joined region of the metal plate 50A and the first sealing portion 51C. The first surface 50a of the metal plate 50A has the electrode exposed portion 50d (hereinafter also called “exposed surface 50d”) that is exposed from the first sealing portion 51C. The heat exchanger 1A is disposed so as to contact the exposed surface 50d.

The outer edge portions of the first sealing portions 51B, 51C that are embedded in the second sealing portion 52 are continuous. Namely, the first sealing portions 51B, 51C are formed by a single film being folded-over in two so as to nip the edge portion 50c of the metal plate 50A therebetween. The outer edge portions of the first sealing portions 51B, 51C are the folded-over portion of the film. The film that structures the first sealing portions 51B, 51C is joined to the edge portion 50c at both the first surface 50a and the second surface 50b of the metal plate 50A.

The first sealing portion 51D is joined to the first surface 50a of the metal plate 50B. The inner side portion 51b of the first sealing portion 51D is positioned between the edge portion 45c of the metal plate 45 of the positive electrode final end electrode 49, and the edge portion 50c of the metal plate 50B, which are adjacent to one another in the stacking direction. The overlapping region of the edge portion 50c at the first surface 50a of the metal plate 50B and the first sealing portion 51D is the joined region of the metal plate 50B and the first sealing portion 51D.

The first sealing portion 51E is disposed at the edge portion 50c at the second surface 50b (the outer surface) of the metal plate 50B. The first sealing portion 51E is not joined to the metal plate 50B. The second surface 50b of the metal plate 50B has the exposed surface 50d that is exposed from the first sealing portion 51E. The heat exchanger 1A is disposed so as to contact the exposed surface 50d.

The outer edge portions of the first sealing portions 51D, 51E that are embedded in the second sealing portion 52 are continuous. Namely, the first sealing portions 51D, 51E are formed by a single film being folded-over in two so as to nip the edge portion 50c of the metal plate 50B therebetween. The outer edge portions of the first sealing portions 51D, 51E are the folded-over portion of the film. The film that structures the first sealing portions 51D, 51E is joined to the edge portion 50c at the first surface 50a of the metal plate 50B.

The plural internal spaces V are provided within the electrode stack 41. The respective internal spaces V are provided between the metal plates that are adjacent to one another. The internal space V is a space that, between metal plates that are adjacent to one another in the stacking direction, are partitioned airtightly and liquid-tightly by those metal plates and the sealing body 42. For example, an electrolytic liquid (not illustrated) is accommodated in the internal spaces V. The electrolytic liquid contains a non-aqueous solvent and a supporting salt for example. Examples of the non-aqueous solvent are organic solvents such as carbonates, ethers, esters, nitriles, sulfones, lactones and the like. Examples of the supporting salt are lithium salts such as LiPF₆ and the like. The electrolytic liquid permeates into the separators 43, the positive electrodes 46 and the negative electrodes 47.

### (1.3.2) Lower Case

The power storage device pack 20 has the lower case 60. The lower case 60 houses the power storage device 30. The shape of the lower case 60 is not particularly limited provided that it is a shape that houses the power storing module 33, and it suffices for the shape to be a known shape. The material of the lower case 60 may be metal, or may be resin. The power storage device pack 20 may be fixed to the lower case 60. The method of fixing the power storage device pack 20 is appropriately selected in accordance with the material of the lower case 60 and the like, and examples thereof are method using parts for fastening, welding, anchoring, depositing, and the like. Examples of parts for fastening are bolts, nuts, screws, rivets, pins and the like. Examples of welding are metal welding and brazing.

### (1.3.3) Cooling Device

The power storage device pack 20 may be equipped with a cooling device (not illustrated) that supplies a cooling medium to the heat exchangers 1A. The cooling device may be a known device.

### (1.3.4) Upper Case

The power storage device pack 20 may have an upper case (not illustrated) that covers the power storage device 30. The shape of the upper case is not particularly limited provided that it is a shape that covers the power storage device 30, and it suffices for the shape to be a known shape. The material of the upper case may be metal, or may be resin. The upper case is fixed to the lower case 60. The method of fixing the upper case is not particularly limited, and examples thereof are the same as the methods exemplified as the method of fixing the power storage device pack 20.

### (1.4) Operation/Effects

As described with reference to FIG. 1 through FIG. 7, the heat exchanger manufacturing method of the first embodiment is a method that manufactures the heat exchanger 1A. The heat exchanger 1A has the first metal plate 11, the second metal plate 12 and the zigzag metal plate 13A. The third metal plate deforms more easily than either of the first metal plate 11 and the second metal plate 12. The heat exchanger manufacturing method includes a layering step and a joining step.

Due thereto, when fluid is supplied under pressure into the first through-hole TH1 and the second through-hole TH2 of the layered plate respectively, the regions of the third metal plate, which are among the regions that structure the first flow paths R1 and the second flow paths R2 respectively, are selectively pushed and widened. At this time, it is difficult for either of the first metal plate 11 and the second metal plate 12 to deform. The heat exchanger manufacturing method of the first embodiment can manufacture the heat exchanger 1A in which the main surface TS11 and the main surface TS12 are flat.

Moreover, the heat exchanger manufacturing method of the first embodiment can manufacture the heat exchanger in which the main surface TS11 and the main surface TS12 are flat, at a lower cost than in a case using a metal mold for the zigzag metal plate 13A.

As described with reference to FIG. 1 through FIG. 7, the heat exchanger manufacturing method of the first embodiment includes a step of supplying under pressure. Due thereto, the first flow paths R1 are formed between the first metal plate 11 and the zigzag metal plate 13A, and the second flow paths R2 are formed between the second metal plate 12 and the zigzag metal plate 13A. As a result, the heat exchanger manufacturing method of the first embodiment can manufacture the heat exchanger 1A in which the main surface TS11 and the main surface TS12 are flat.

As described above with reference to FIG. 1 through FIG. 7, in the first embodiment, the zigzag metal plate 13A does not have third through-holes that communicate the first flow paths R1 and the second flow paths R2. The plural mountain portions M13 include the plural rectilinear mountain portions M13A (an example of the first mountain portions). The plural valley portions V13 include the plural rectilinear valley portions V13A (an example of the first valley portions).

Due thereto, the first flow paths R1 and the second flow paths R2 are independent. When a fluid is supplied under pressure from the first through-hole TH1 of the layered plate, it is easier for the distribution of the magnitude of the pressure applied to the first metal plate 11 to be uniform, than in a case in which the plural mountain portions M13 do not include the plural rectilinear mountain portions M13A that are formed so as to be spaced apart at the first interval L6. When a fluid is supplied under pressure from the second through-hole TH2 of the layered plate, it is easier for the distribution of the magnitude of the pressure applied to the second metal plate 12 to be uniform, than in a case in which the plural valley portions V13 do not include the plural rectilinear valley portions V13A that are formed so as to be spaced apart at the second interval L7. As a result, the heat exchanger manufacturing method of the first embodiment can manufacture the heat exchanger 1A in which the main surface TS11 and the main surface TS12 are flat.

As described with reference to FIG. 1 through FIG. 7, in the first embodiment, the rectilinear mountain portions M13A and the rectilinear valley portions V13A extend along the Y-axis direction (an example of the second direction). The rectilinear mountain portions M13A and the rectilinear valley portions V13A are formed alternately along the X-axis direction (an example of the first direction).

Due thereto, when a fluid is supplied under pressure from the first through-hole TH1 of the layered plate, it is even easier for the distribution of the magnitude of the pressure applied to the first metal plate 11 to be uniform. When a fluid is supplied under pressure from the second through-hole TH2 of the layered plate, it is even easier for the pressure that is applied to the second metal plate 12 to be uniform. As a result, the heat exchanger manufacturing method of the first embodiment can manufacture the heat exchanger 1A in which the main surface TS11 and the main surface TS12 are flat.

As described above with reference to FIG. 1 through FIG. 7, in the first embodiment, either of the first metal plate 11 and the second metal plate 12 contain a 6000 series aluminum alloy. The third metal plate contains a 1000 series aluminum.

Namely, it is easier for the third metal plate to deform than either of the first metal plate 11 and the second metal plate 12. As a result, the heat exchanger manufacturing method of the first embodiment can manufacture the heat exchanger 1A in which the main surface TS11 and the main surface TS12 are flat.

As described above with reference to FIG. 1 through FIG. 7, in the first embodiment, the respective thicknesses of the first metal plate 11 and the second metal plate 12 are greater than or equal to 1.00 mm. The thickness of the third metal plate is less than 1.00 mm. Namely, it is easier for the third metal plate to deform than either of the first metal plate 11 and the second metal plate 12. As a result, the heat exchanger manufacturing method of the first embodiment can manufacture the heat exchanger 1A in which the main surface TS11 and the main surface TS12 are flat.

As described above with reference to FIG. 1 through FIG. 7, the heat exchanger manufacturing method of the first embodiment further includes the readying step, the first release agent coating step, and the second release agent coating step.

Due thereto, the first metal plate 11 and the plural mountain portions M13 are joined by brazing. The second metal plate 12 and the plural valley portions V13 are joined by brazing. As a result, the heat exchanger manufacturing method of the first embodiment can manufacture the heat exchanger 1A more simply than in a case in which the joining method is not brazing.

As described above with reference to FIG. 1 through FIG. 7, the heat exchanger 1A of the first embodiment has the first metal plate 11, the second metal plate 12 and the zigzag metal plate 13A. The zigzag metal plate 13A has the plural mountain portions M13 that are joined to the first metal plate 11, and the plural valley portions V13 that are joined to the second metal plate 12. The first flow paths R1 are formed between the first metal plate 11 and the zigzag metal plate 13A, and the second flow paths R2 are formed between the second metal plate 12 and the zigzag metal plate 13A. The zigzag metal plate 13A deforms more easily than either of the first metal plate 11 and the second metal plate 12.

The heat exchanger 1A is suitably manufactured by the heat exchanger manufacturing method of the first embodiment. Therefore, the main surface TS11 and the main surface TS12 of the heat exchanger 1A are flat. As a result, the heat exchanger 1A can efficiently cool the power storing module 33.

As described above with reference to FIG. 1 through FIG. 7, at the heat exchanger 1A of the first embodiment, the main surface TS11 of the first metal plate 11 and the main surface TS12 of the second metal plate 12 are each planar.

Due thereto, it is easier for the main surface TS11 of the first metal plate 11 and the main surface TS12 of the second metal plate 12 respectively to directly contact the power storing modules 33 than in a case in which the main surface TS11 of the first metal plate 11 and the main surface TS12 of the second metal plate 12 are not each planar. As a result, the heat exchanger 1A can more efficiently cool the power storing module 33.

As described above with reference to FIG. 1 through FIG. 7, in the first embodiment, the thickness of the heat exchanger 1A is less than or equal to 10 mm.

Due thereto, the heat exchanger 1A is suitably used as a cooler for cooling the power storing modules 33 included in the power storage device 30.

As described above with reference to FIG. 1 through FIG. 7, the power storage device 30 of the first embodiment has the plural power storing modules 33 and the plural heat exchangers 1A. Between the power storing modules 33 that are adjacent to one another in the stacking direction, the heat exchangers 1A are disposed between the electrode exposed portions 50d, which face one another, so as to contact the electrode exposed portions 50d. The main surface TS11 and the main surface TS12 of the heat exchanger 1A are flat. Therefore, the surface area of contact between the electrode exposed portion 50d and the heat exchanger 1A is greater than in a case in which the main surface TS11 and the main surface TS12 of the heat exchanger 1A are not flat. As a result, the power storage device 30 can efficiently cool the power storing modules 33.

As described above with reference to FIG. 1 through FIG. 7, the power storage device pack 20 of the first embodiment has the power storage device 30 and the lower case 60. Due thereto, the power storage device pack 20 can efficiently cool the power storing modules 33.

### (2) Second Embodiment

A heat exchanger manufacturing method of a second embodiment of the present disclosure mainly is similar to the heat exchanger manufacturing method of the first embodiment, except that the zigzag metal plate has through-holes.

The heat exchanger manufacturing method of the second embodiment is a method that manufactures a heat exchanger 1B.

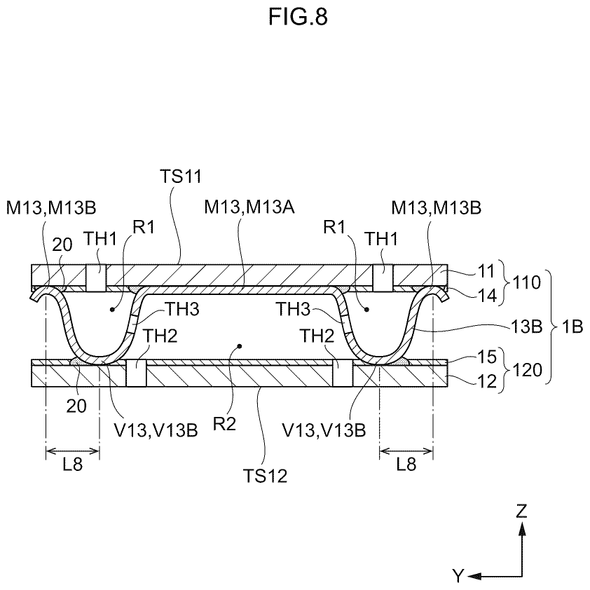

As illustrated in FIG. 8, the heat exchanger 1B has the first metal plate 11, the second metal plate 12, a zigzag metal plate 13B, the first brazing material layer 14 (see FIG. 2) and the second brazing material layer 15 (see FIG. 2). The structure of the zigzag metal plate 13B is similar to that of the zigzag metal plate 13A, except that the zigzag metal plate 13B has third through-holes TH3 that communicate the first flow paths R1 and the second flow paths R2.

As described with reference to FIG. 8, in the second embodiment, the zigzag metal plate 13B further has the plural third through-holes TH3 that communicate the first flow paths R1 and the second flow paths R2. The plural mountain portions M13 include the plural rectilinear mountain portions M13A (an example of the first mountain portions). The plural valley portions V13 include the plural rectilinear valley portions V13A (an example of the first valley portions). The first interval L6 and the second interval L7 are equal.

Due thereto, when a fluid is supplied under pressure from the first through-hole TH1 and the second through-hole TH2 of the layered plate, it is easier for the distributions of the magnitudes of the pressures applied to either of the first metal plate 11 and the second metal plate 12 to be uniform, than in a case in which the first interval L6 and the second interval L7 are not equal. As a result, the heat exchanger manufacturing method of the second embodiment can manufacture the heat exchanger 1B in which the main surface TS11 and the main surface TS12 are even more flat.

### (3) Modified Examples

The heat exchanger manufacturing methods of the first embodiment and the second embodiment include the readying step, the first release agent coating step, the second release agent coating step, the layering step, the joining step, and the step of supplying under pressure. However, provided that the heat exchanger manufacturing method of the present disclosure includes the layering step and the joining step, the method does not have to include at least one of the readying step, the first release agent coating step and the second release agent coating step, and the step of supplying under pressure.

In the first embodiment, the plural mountain portions M13 include the plural rectilinear mountain portions M13A, and the plural valley portions V13 include the plural rectilinear valley portions V13A. However, in the heat exchanger manufacturing method of the present disclosure, the plural mountain portions M13 do not have to include the plural rectilinear mountain portions M13A, and the plural valley portions V13 do not have to include the plural rectilinear valley portions V13A.

In the first embodiment, the first interval L6 and the second interval L7 are equal, but the first interval L6 and the second interval L7 may be different. In the first embodiment, the first flow paths R1 and the second flow paths R2 are independent. Therefore, even if the first interval L6 and the second interval L7 are different, the heat exchanger manufacturing method of the first embodiment can manufacture the heat exchanger in which the main surface TS11 and the main surface TS12 are flat.

In the first embodiment and the second embodiment, the plural rectilinear mountain portions M13A (an example of the first mountain portions) and the plural rectilinear valley portions V13A (an example of the first valley portions) respectively extend along the Y-axis direction. However, in the present disclosure, the plural rectilinear mountain portions M13A and the plural rectilinear valley portions V13A respectively do not have to extend along the Y-axis direction. For example, the first mountain portions and the second valley portions may be shaped as curves toward the Y-axis positive direction.

In the first embodiment and the second embodiment, either of the first metal plate 11 and the second metal plate 12 contain a 6000 series aluminum alloy, and the third metal plate contains a 1000 series aluminum. However, in the present disclosure, either of the first metal plate 11 and the second metal plate 12 do not have to contain a 6000 series aluminum alloy, and the third metal plate does not have to contain a 1000 series aluminum. The respective materials of the first metal plate 11, the second metal plate 12 and the third metal plate are selected appropriately in accordance with the respective thicknesses and the like of the first metal plate 11, the second metal plate 12 and the third metal plate, and it suffices for the materials to be metal.

In the first embodiment and the second embodiment, the respective thicknesses of the first metal plate 11 and the second metal plate 12 are greater than or equal to 1.00 mm, and the thickness of the third metal plate is less than 1.00 mm. However, in the present disclosure, the respective thicknesses of the first metal plate 11 and the second metal plate 12 may be less than 1.00 mm, and the thickness of the third metal plate may be greater than or equal to 1.00 mm. The respective thicknesses of the first metal plate 11, the second metal plate 12 and the third metal plate are selected appropriately in accordance with the respective materials of the first metal plate 11, the second metal plate 12 and the third metal plate, and the like.

In the case of an aspect in which the heat exchanger manufacturing method of the present disclosure does not include the readying step, the first release agent coating step and the second release agent coating step (hereinafter “the first case”), the plural mountain portions of the zigzag metal plate may be joined to the first metal plate by a joining method that is different than brazing, and the plural valley portions of the zigzag metal plate may be joined to the second metal plate by a joining method that is different than brazing. The joining method that is different than brazing is appropriately selected in accordance with the respective materials of the first metal plate, the second metal plate and the third metal plate, and the like, and examples are welding (e.g., laser welding or the like), depositing (e.g., friction stir welding (FSW), friction stir spot welding (FSSW), and the like), and the like. If the heat exchanger manufacturing method of the present disclosure is the first case, the heat exchanger 1A and the heat exchanger 1B respectively do not have to have the first brazing material layer 14 and the second brazing material layer 15. If the heat exchanger manufacturing method of the present disclosure is the first case, the joining of the first metal plate and the third metal plate at the regions of the layered plate that correspond to the mountain portions, and the joining of the second metal plate and the third metal plate at the regions of the layered plate that correspond to the valley portions, may be executed separately and not simultaneously.

At the heat exchanger 1A and the heat exchanger 1B, the main surface TS11 and the main surface TS12 are planar. However, in the present disclosure, the main surface TS11 and the main surface TS12 do not have to be planar. For example, a projecting portion, which projects-out in the thickness direction (the Z-axis direction) of the heat exchanger 1A and the heat exchanger 1B, may be provided at the respective peripheral edges of the main surface TS11 and the main surface TS12.

Although the respective thicknesses of the heat exchanger 1A and the heat exchanger 1B are less than or equal to 10 mm, in the present disclosure, the respective thicknesses of the heat exchanger 1A and the heat exchanger 1B may be greater than 10 mm.

In the first embodiment and the second embodiment, the heat exchange medium is a cooling medium. However, in the present disclosure, the heat exchange medium may be a heating medium. In a case in which the heat exchange medium is a heating medium, the heat exchanger 1A and the heat exchanger 1B can heat the targets of the heat exchange which thermally contact the main surface TS11 and the main surface TS12, respectively. Examples of heating media are liquids for heating, gasses for heating, and the like. The liquids for heating are not particularly limited provided that they are liquids that are generally used as liquids for heating, and examples thereof are water, oil, glycol-based aqueous solutions, coolants for air conditioning, non-electrically conductive liquids, phase change liquids, and the like. Examples of gasses for heating are air, water vapor and the like. The temperature of the heating medium is adjusted appropriately in accordance with the type of the target of the heat exchange, and the like.

What is claimed is:

1. A method of manufacturing a heat exchanger, wherein:
the heat exchanger has a first metal plate having at least one first through-hole, a second metal plate having at least one second through-hole, and a zigzag metal plate disposed between the first metal plate and the second metal plate, the zigzag metal plate comprising a third metal plate formed in a zigzag shape,
the zigzag metal plate has a plurality of mountain portions joined to the first metal plate and a plurality of valley portions joined to the second metal plate,
first flow paths that communicate with the at least one first through-hole are formed between the first metal plate and the zigzag metal plate, and second flow paths that communicate with the at least one second through-hole are formed between the second metal plate and the zigzag metal plate, and
the third metal plate deforms more easily than either of the first metal plate and the second metal plate,
the method comprising:
preparing a layered plate by layering the first metal plate, the third metal plate and the second metal plate in this order;
joining the first metal plate and the third metal plate at regions of the layered plate that correspond to the mountain portions; and
joining the second metal plate and the third metal plate at regions of the layered plate that correspond to the valley portions.

2. The heat exchanger manufacturing method of claim 1, further comprising supplying a fluid under pressure into the at least one first through-hole and the at least one second through-hole respectively, and pushing and widening the third metal plate.

3. The heat exchanger manufacturing method of claim 1, wherein:
the zigzag metal plate does not have third through-holes that communicate the first flow paths and the second flow paths,
the plurality of mountain portions include a plurality of first mountain portions formed so as to be spaced apart at a first interval along a first direction that is orthogonal to a thickness direction of the heat exchanger, and
the plurality of valley portions include a plurality of first valley portions formed so as to be spaced apart at a second interval along the first direction.

4. The heat exchanger manufacturing method of claim 3, wherein:
the first mountain portions and the first valley portions respectively extend along a second direction that is orthogonal to each of the first direction and the thickness direction of the heat exchanger, and
the first mountain portions and the first valley portions are formed alternately along the first direction.

5. The heat exchanger manufacturing method of claim 1, wherein:
the first metal plate and the second metal plate respectively contain a 6000 series aluminum alloy, and
the third metal plate contains a 1000 series aluminum.

6. The heat exchanger manufacturing method of claim 1, wherein:
respective thicknesses of the first metal plate and the second metal plate are greater than or equal to 1.00 mm, and
a thickness of the third metal plate is less than 1.00 mm.

7. The heat exchanger manufacturing method of claim 1, wherein:
the zigzag metal plate further has at least one third through-hole that communicates the first flow paths and the second flow paths,
the plurality of mountain portions include a plurality of first mountain portions formed so as to be spaced apart at a first interval along a first direction that is orthogonal to a thickness direction of the heat exchanger,
the plurality of valley portions include a plurality of first valley portions formed so as to be spaced apart at a second interval along the first direction, and
the first interval and the second interval are equal.

8. The heat exchanger manufacturing method of claim 1, further comprising:
readying a first brazing sheet in which a first brazing material layer for joining the plurality of mountain portions to the first metal plate is formed on one main surface of the first metal plate, and a second brazing sheet in which a second brazing material layer for joining the plurality of valley portions to the second metal plate is formed on one main surface of the second metal plate;
imparting the first brazing sheet with release agent by coating a first release agent on, of a main surface of the first brazing material layer, regions other than regions at which the plurality of mountain portions are to be joined; and
imparting the second brazing sheet with release agent by coating a second release agent on, of a main surface of the second brazing material layer, regions other than regions at which the plurality of valley portions are to be joined, wherein:
preparing the layered plate includes layering the first brazing sheet with release agent, the third metal plate and the second brazing sheet with release agent such that the first metal plate, the first brazing material layer, the third metal plate, the second brazing material layer and the second metal plate are layered in this order, and
joining the first metal plate and the third metal plate and joining the second metal plate and the third metal plate, includes heating the layered plate, brazing the first metal plate and the third metal plate, and brazing the second metal plate and the third metal plate.

9. A heat exchanger, comprising a first metal plate having at least one first through-hole, a second metal plate having at least one second through-hole, and a zigzag metal plate disposed between the first metal plate and the second metal plate, the zigzag metal plate comprising a third metal plate formed in a zigzag shape, wherein:
the zigzag metal plate has a plurality of mountain portions joined to the first metal plate and a plurality of valley portions joined to the second metal plate,
first flow paths that communicate with the at least one first through-hole are formed between the first metal plate and the zigzag metal plate, and second flow paths that communicate with the at least one second through-hole are formed between the second metal plate and the zigzag metal plate, and
the zigzag metal plate deforms more easily than either of the first metal plate and the second metal plate.

10. The heat exchanger of claim 9, wherein a main surface of the first metal plate and a main surface of the second metal plate are each planar.

11. The heat exchanger of claim 9, wherein a thickness of the heat exchanger is less than or equal to 10 mm.

12. A power storage device, comprising:
a plurality of power storing modules that are stacked; and
a plurality of the heat exchangers according to any one of claim 9, which are provided between the power storing modules that are adjacent to one another in a stacking direction of the power storing modules, wherein:
each of the power storing modules has an electrode stack including a plurality of electrodes layered via separators along the stacking direction of the power storing modules, an electrolytic liquid accommodated in internal spaces formed between the electrodes that are adjacent to one another, and a sealing body that surrounds side surfaces, which run along the stacking direction, of the electrode stack and that seals the internal spaces,
the plurality of electrodes include a negative electrode final end electrode, a positive electrode final end electrode, and a plurality of bipolar electrodes layered between the negative electrode final end electrode and the positive electrode final end electrode,
each of the plurality of bipolar electrodes includes an electrode plate, a positive electrode provided on a first surface of the electrode plate, and a negative electrode provided on a second surface of the electrode plate,
the electrode stack has, at one end and another end in the stacking direction, electrode exposed regions that are exposed from the sealing body, and
between the power storing modules that are adjacent to one another in the stacking direction, the heat exchangers are disposed between the electrode exposed regions that face one another, so as to contact the electrode exposed regions.

13. A power storage device pack, comprising:
the power storage device of claim 12; and
a lower case accommodating the power storage device.
